(19) United States
(12) Patent Application Publication
(10) Pub. No.: US 2026/0216980 A1
(43) Pub. Date: Jul. 30, 2026

(54) Lens, in particular, an Ophthalmic Lens, a Method and Device for Producing a Lens, and a Casting Package Comprising the Lens

(71) Applicant: Rodenstock GmbH, Muenchen (DE)

(72) Inventors: Helmut Rauch, Regen (DE); Yven Rohlfing, Muenchen (DE); Udo Weigand, Muenchen (DE); Herbert Zinner, Rohrbach (DE); Alexander Ebner, Achslach (DE); Christoph Traulsen, Muenchen (DE)

(73) Assignee: Rodenstock GmbH, Muenchen (DE)

(21) Appl. No.: 19/141,602

(22) PCT Filed: Dec. 15, 2023
(86) PCT No.: PCT/EP2023/086186

§ 371 Date: Jun. 20, 2025

(30) Foreign Application Priority Data
Dec. 22, 2022 (DE) 10 2022 004 865.5
Oct. 24, 2023 (DE) 10 2023 210 501.2

(51) Int. Cl. B29D 11/00; B29K 81/00; B29K 105/00

(52) U.S. Cl. CPC B29D 11/00865; B29D 11/00413; B29D 11/00442; B29D 11/00653; B29K 2081/00; B29K 2105/0032

(57) ABSTRACT

A method for producing a lens, in particular a spectacle lens, includes at least one of the following steps: providing a main body, providing a mold shell, arranging the main body and the mold shell in such a way that a cavity is formed between the main body and the mold shell, applying a sealing tape to seal the cavity formed between the main body and the mold shell to obtain a casting package, forming at least one opening in the sealing tape, arranging the casting package in a holding apparatus, filling the cavity with a casting resin through the at least one opening, closing the opening, removing the casting package filled with a casting resin from the holding apparatus, curing the casting package, removing the sealing tape, and removing the mold shell to obtain a lens.

### CROSS-REFERENCE TO RELATED APPLICATIONS

This application is a national phase application under 35 U.S.C. § 371 of International Patent Application No. PCT/EP2023/086186, filed Dec. 15, 2023 (pending), which claims the benefit of priority to German Patent Application Nos. DE 10 2022 004 865.5, filed Dec. 20, 2022, and DE 10 2023 210 501.2, filed Oct. 24, 2023, the disclosures of which are incorporated by reference herein in their entirety.

### TECHNICAL FIELD

The present invention relates to a method and a device for producing a lens, in particular an ophthalmic lens, by filling a casting package, in particular a casting package with a small gap dimension and/or with a casting resin for forming a photochromic coating, as well as the casting package and a lens, which is preferably ophthalmic and/or comprising at least one photochromic coating.

### BACKGROUND

Lenses, in particular ophthalmic lenses, preferably spectacle lenses, can be produced in different ways. A well-known production process is a casting process in which a front and a rear mold shell, also called a casting mold, are used. Such a mold shell is a negative mold or negative mask of the shape of the lens to be obtained later, i.e., for a convex or concave face of a lens to be cast, a mold shell is required which comprises an opposite shape, i.e., a concave or convex shape. Of course, a variety of other shapes are also conceivable and are also used to produce customized lenses. In such a casting process, a front and a rear mold shell are positioned at a defined distance from each other and then a casting resin, which forms the later lens after curing, is poured into the resulting cavity defined by the front and rear mold shells. Depending on the composition of the components forming the casting resin, curing then takes place either thermally, i.e., by tempering at a temperature that promotes the curing of the casting resin, or photochemically, i.e., by causing a chemical reaction by irradiation with electromagnetic radiation of a suitable wavelength, which is understood in particular to mean a process in which the casting resin cures by irradiation with UV radiation. The casting resins used for this are not strongly restricted and only have to satisfy the requirement of being of sufficient optical quality with regard to the optical imaging properties of the later lens. In addition, the casting resins can contain further components that give the later lens desired, preferred properties, such as an adapted refractive index or desired absorption properties, such as in particular protection against harmful UV radiation. After curing, the front and back mold shells are removed, and the lens is thereby obtained. Further processing or finishing steps may then follow, such as incorporating a defined optical effect or, in the case of an ophthalmic lens, an optical prescription to correct an ascertained visual impairment by means of suitable processing methods, in particular milling and grinding, as well as the application of various coatings to obtain a break-resistant, scratch-resistant, possibly photochromic, anti-reflective or reflective and/or dirt-repellent lens. In particular, if the lens thus obtained undergoes further processing steps, a lens produced in this way represents an intermediate product from the point of view of the entire production process, which is why the present object is also referred to as a semi-finished part or semi-finished product, lens semi-finished part or lens semi-finished product, or analogously as a spectacle lens semi-finished part or spectacle lens semi-finished product.

Self-tinting or photochromic lenses can react to UV radiation. Depending on the intensity of the UV radiation hitting the spectacle lens, such a lens tints dark or light. The darkening or lightening of the lens is made possible by a functional coloration with which the lens is provided. The functional coloration is caused by a photochromic dye, which reacts with a reversible change in its molecular structure, also known as isomerization, and thus also changes its absorption behavior in response to irradiation with UV radiation. When the UV radiation decreases, the photochromic dye returns to its original molecular structure and thus also its original absorption behavior. A photochromic dye thus allows for reversible switching between a dark and a light tinting. Such functional coloration can be achieved in various ways. One type is the production method also known as mass coloration, using the casting process mentioned above with the direct addition of the dye to the casting resin. The functional coloration can also be applied to a lens by coating the lens with a thin layer or by providing it with a ply containing a photochromic dye.

From the prior art, a person skilled in the art has knowledge of a plurality of possibilities for applying or forming additional, thin layers, such as photochromic coatings, to a lens, including in particular spin coating and dip coating.

In the case of dip coating, the lens to be coated is immersed in a dip bath containing at least one photochromic dye, resulting in a photochromic coating on both sides of the lens. Such a dip coating is not very complex in terms of equipment and can be carried out in conventional dip coating installations, but has the disadvantage that the cosmetic appearance required for ophthalmic lenses is difficult to achieve and/or that there is a high material consumption due to the double-sided coating, which represents an economic disadvantage due to the resulting increased production costs, in particular with complex photochromic dyes.

Although spin coating involves applying the desired photochromic coating to only one of the two sides of the lens, thus reducing the material requirements, this method has the disadvantage that spin coating requires a batch size of one piece, which is time-consuming to handle and leaves little room for cost-reducing automation measures.

In particular, the production of a photochromic lens, in particular a photochromic ophthalmic lens, cannot be achieved, or not without disadvantages, using a casting process as mentioned above, with the addition of photochromic dyes to a casting resin. One reason for this is that UV absorbers are usually added to casting resins for ophthalmic lenses in order to provide the ophthalmic lens thus produced with protection against harmful UV radiation. UV absorbers are in principle in competition with a photochromic dye, since both react to incident UV radiation. Another reason is the cross-linking of the casting resin during curing, which negatively influences the isomerization behavior of the photochromic dyes or limits it to such an extent that a photochromic reaction can only take place with severe impairment or does not occur at all. In addition to the technical reasons, there are also economic reasons. In such a casting process, the volume between the two mold shells, which forms the later lens, usually comprises an average thickness in the range of several millimeters in order to give the later lens a minimum degree of resistance to breakage. The addition of complex, highly specific photochromic dyes into a casting resin would require a large quantity of photochromic dyes, which would significantly increase the production costs of such a photochromic spectacle lens. Even greater is the amount of dye that is removed and discarded during the surface treatment of the semi-finished part mentioned above.

Accordingly, for the production of lenses with at least one, in particular non-linear, optical functionality, it can be advantageous to separate this functionality as a layer (coating) or overlay from a lens main body, for example a lens or spectacle lens semi-finished part mentioned above. This applies in particular to the provision of an ophthalmic and/or plastics lens, in particular a spectacle lens, with at least one photochromic coating or ply, which preferably comprises at least one photochromic organic dye. Therefore, the present invention will be explained below in part with reference to this particularly preferred application of a lens, in particular a spectacle lens, with at least one, preferably thin, photochromic coating, without however being limited thereto.

### SUMMARY

The object is to provide an improved method for producing a lens, in particular a method which addresses the previously discussed disadvantages with regard to the production of a lens with a thin layer, which is particularly preferably understood to mean a photochromic coating.

This object is achieved by a method as disclosed herein.

Another object can be to provide a device for carrying out a method described here or to provide an advantageous lens, which is preferably ophthalmic and/or produced according to a method described here, or to provide a casting package for obtaining the lens according to a method described here.

This object is achieved by a device as disclosed herein, which is designed or used to carry out a method described here, or by a casting package which is obtained by a method described here and/or is designed or used to obtain a lens according to a method described here, or by a lens or a lens produced according to a method described here. Accordingly, the present explanations and/or features apply equally to an inventive method, an inventive device, an inventive casting package and an inventive lens, even if they are mentioned only with reference to one of these aspects. In particular, the use of a casting package described here in a method described here, or the use of a device described here for carrying out a method described here, is also protected.

One aspect of the invention relates to a method for producing a lens, in particular a spectacle lens, comprising at least one of the following steps:
S100: providing a main body,
S102: providing a mold shell,
S104: arranging the main or glass body and the mold shell in such a way that a cavity is formed between the main or glass body and the mold shell,
S106: applying a sealing tape to seal the cavity formed between the main or glass body and the mold shell to obtain a casting package,
S108: forming at least one opening in the sealing tape,
S110: arranging the casting package in a holding apparatus,
S112: filling the cavity with a casting resin through the at least one opening,
S114: closing the opening,
S116: removing the casting package filled with a casting resin from the holding apparatus,
S118: curing the casting package,
S120: removing the sealing tape, and
S122: removing the mold shell to obtain a lens.

The inventive method allows for the production of a lens by means of a sprue process. Preferably, the method comprises at least the steps S100, S102, wherein the mold shell can be provided before, after or with the main body, the steps S104, S106, S112, S120 and S122, preferably in this order, wherein in an advantageous further development one or more of the steps S108, S110 and S116, S114 and S118 are provided, preferably in the order indicated by the (ascending) numbering of the steps with reference to one another and/or the aforementioned steps S100, S102, S104, S106, S112, S120 and S122, without the invention being restricted thereto.

Advantageously, the surface of the coating applied in one embodiment by (curing the) casting resin can be shaped, and, in a preferred case, i.e., in the case of a coating that is as homogeneous as possible, which is understood to mean a uniform coating and a constant coating that is almost location-independent with regard to its layer thickness, the surface of the coating is almost identical to the surface of the uncoated lens. Preferably, a modification of the surface, which can be understood in particular as a structuring with, for example, deliberate elevations, can be achieved by means of this method.

Advantageously, this method can be used to produce a coating or a sprue or an overlay on a main body which comprises a small gap dimension of preferably less than 1,000 μm, particularly preferably of a few hundred micrometers, preferably of less than 500 μm. In one embodiment, a gap dimension of the cavity, in one embodiment maximum or averaged over its course, is less than one thousand micrometers (1,000 μm), particularly preferably less than 500 μm. In one embodiment, the casting resin forms a photochromic coating; for this purpose it can in particular comprise at least one photochromic, particularly preferably organic, dye. For such thin and/or photochromic coatings, the present invention is not limited thereto but is quite particularly advantageous, in particular due to the requirements in production and/or with regard to quality and/or materials. The coating formed by the casting resin can comprise or realize at least one other optical functionality instead of the photochromic one, or at least one other optical functionality besides the photochromic one. In a preferred embodiment, the mold shell or casting mold is arranged on an object-side, or environment-side, or non-eye-side, front side of the main body, so that the coating formed by the casting resin is correspondingly formed or arranged on an object-side or environment-side or non-eye-side front side of the lens, which can be particularly advantageous functionally.

In a method step S100, a main body is provided, which can be understood as any substrate or carrier material onto which a casting resin is cast by means of this method, which, after appropriate curing, leads to the production of a sprue or a layer or an overlay or an additional component or an additional ply on the main body. In order to be suitable for later use as a lens, the main body should have sufficient optical quality with regard to optical imaging properties. A person skilled in the art understands optical imaging properties to be a plurality of determinable, characteristic quantities which can characterize a given object, such as in particular a main body, with regard to its optical imaging properties, including properties such as spectral transmission, color rendering, or the Abbe number. In particular, in the use of plastics as materials for the production of lenses, in particular spectacle lenses or ophthalmic lenses, materials such as poly(thio)urethane, polyacrylate, polymethyl methacrylate, polycarbonate, polydiethylene glycol bisallyl carbonate or combinations thereof have proven to be preferred in recent years, although in principle other transparent plastics materials can also be used. Accordingly, in one embodiment the main body comprises a plastics material; in particular it can be a plastics material main body, preferably a plastics material base glass. In a preferred embodiment, the main body has been produced using a casting process as mentioned above and comprises at least a first optical effect and can therefore also be referred to as a semi-finished part, since at least the first or the second side or face or both sides or faces of the main body are already formed in a desired geometric shape, which is understood in particular to mean a defined radius of curvature. Such a main body can also be a finished processed lens which is provided with an additional layer or an additional overlay during the method.

In one embodiment, the main body (on which the subsequent sprue is made) comprises plastics material, preferably of corresponding optical quality, which is composed of polymerizable molecules, preferably of optical quality; in a further development, the main body is made of such plastics material. These polymerizable compounds can in particular be monomers, oligomers and/or prepolymers. Preferably, one or more or combinations of the following are used to provide, or as, thermally curable polyurethane and polythiourethane casting resins, in particular for producing the main body: multifunctional isocyanates, isothiocyanates and/or episulfides, multifunctional alcohols and/or thiols. Likewise preferably, one or more or combinations of the following are used to provide, or as, thermally and/or photochemically curable polyacrylate and polymethyl methacrylate casting resins, in particular for producing the main body: multi- and/or monofunctional acrylates and/or methyl methacrylates. Likewise preferably, one or more or combinations of the following are used to provide, or as, thermally curable polycarbonate and polydiethylene glycol bis(allyl carbonate) casting resins, in particular for producing the main body: multi- and/or monofunctional allyl carbonates and/or diethylene glycol bis(allyl carbonates).

Such compositions or plastics materials are offered under trademarked trade names such as CR-39, CR-607, CR-630, or MR-7, MR-8 and MR-10. CR-39 or Columbia Resin 39 is a thermosetting polymer material sold by Pittsburgh Plate Glass Industries (PPG Industries). CR-607 and CR-630 are also from PPG Industries. The trade names MR-7, MR-8 and MR-10 are polythiourethanes marketed by Mitsui Chemicals. The abbreviation “MR” stands for Mitsui Resin.

In addition or as an alternative to these preferred materials, in particular other transparent plastics materials may also be used without restriction.

In a further method step S102, which, as already mentioned, can be carried out before, with or after method step S100, a mold shell is provided, which is understood to be an object which comprises at least one face which corresponds to the opposite shape of the desired lens face to be obtained after carrying out the method. This face of the mold shell represents the negative image of the lens surface to be obtained. In the simplest case, the mold shell therefore comprises a curved surface which is concave or convex depending on the desired face of the lens to be obtained, if the lens surface to be obtained is to be correspondingly convex or concave. Of course, combinations of these are also conceivable, as are in particular any shapes. Advantageously, there can also be structures in the mold shell, and it would thus also be conceivable to provide the mold shell with recesses that leave corresponding elevations on the lens after spruing, which can lead to the formation of microlenses. Preferably, by using such an adapted mold shell, a plurality of microlenses can be formed on the subsequent lens, which can be particularly advantageous when using such a lens as an ophthalmic lens in a spectacle lens, in particular for the treatment of myopia.

In a further method step S104, the previously provided main body and the provided mold shell are put into place. This preferably means that the main body and the mold shell are arranged or positioned relative to one another in such a way that the main body and the mold shell are at a defined distance from one another and a cavity is thereby formed between the main body and the mold shell. Preferably, the main body and the mold shell are arranged relative to one another in such a way that a cavity is formed between them with a small gap dimension, which is preferably understood to mean a gap dimension, in particular a maximum gap dimension or a gap dimension averaged over its course, of less than or equal to 1000 μm, preferably less than or equal to 500 μm.

A further method step S106 comprises the application of a sealing tape in such a way that a sealing, preferably impermeable to gas and/or liquid, in one embodiment a sealing that is airtight and/or (liquid)-impermeable with respect to the liquid casting resin, takes place of the cavity formed between the main body and the mold shell. The choice of a suitable sealing tape is not strongly restricted here. In principle, any suitable adhesive tape is conceivable, as long as it ensures the required sealing, adheres to the main body and the mold shell, and at the same time can be detached and removed in a later method step. Preferably, the sealing tape comprises a high chemical resistance to the casting resin used and is advantageously pressure-resistant, since in one embodiment the method is intended to allow for the subsequent filling of the cavity, in particular with high-viscosity casting resins. In addition, the filling time can be shortened if filling takes place under higher pressures. The sealing tape can be applied either manually or by a suitable device which comprises the sealing tape used for sealing in a reservoir, preferably on a roll, and then rolls or wraps at least one ply of the sealing tape around the structure consisting of the mold shell and the main body by an unwinding or unwrapping process, with the aim of obtaining the required (gas- and liquid-impermeable) seal. In one embodiment, the sealing tape comprises a carrier material, preferably made of PET, OPP, or the like, and/or an adhesive, preferably an acrylic adhesive, silicone adhesive or the like. These are particularly suitable due to the requirements of filling with casting resin, in a preferred embodiment under overpressure.

An object obtained in this way, consisting of a main body, a mold shell arranged at a defined distance therefrom, forming a cavity, and enclosed with a sealing tape, is also referred to as a casting package.

A further method step S108 can comprise the formation of at least one first opening in the sealing tape in order to be able to fill a casting resin into the cavity via said opening at a later time (“inlet opening” or “filling opening”). Such a first opening can be formed and optionally carried out by a device which is suitable for carrying out a mechanical process for forming a first opening, such as cutting, piercing or punching, or a thermal process for forming a first opening, such as targeted thermal heating or decomposition with a hot object or with an object comprising a hot surface which is brought into contact with the sealing tape at the desired location to form a first opening, or by means of a focused laser pulse which brings about targeted thermal decomposition at the desired location to form a first opening. In addition to a first opening as an inlet opening, at least one further, second opening can also be formed, which serves to allow the air displaced during the subsequent filling of the cavity to escape (“outlet opening”). Preferably, such a second opening is positioned opposite the first opening. Alternatively, the formation of a second opening as an outlet opening can be omitted if the cavity is evacuated before filling. Preferably, such evacuation takes place after formation of a first opening; particularly preferably, the device used to form the opening and/or for the filling with casting resin comprises, optionally in addition to its mechanical or thermal component for forming the opening, a corresponding property for evacuation. In addition, a plurality of openings can be formed, for example to enable filling not only from one position, but from a plurality of positions simultaneously. Alternatively, the sealing tape used can already be provided with one or more openings, so that in the inventive method step S108 can be omitted or not be part of an inventive method or can be carried out before the sealing tape is applied, preferably by a third party such as a supplier of the sealing tape or the like. In one embodiment, the sealing tape comprises one or more openings, in particular the, or one or more, inlet opening(s) and/or the, or one or more, outlet opening(s), which is/are formed before the sealing tape is applied, in an embodiment in which the method comprises step S108. The formation of an opening or of a plurality of such openings takes place at a defined location, preferably in such a way that such an opening comprises a defined size and neither the main body nor the mold shell are damaged when the opening is created. The opening(s) to be formed are defined with regard to their size or diameter. The diameter is chosen so that, on the one hand, a desired volume flow can be achieved when filling with casting resin, and on the other hand the size of the opening is not larger than the dimension of the cavity behind it.

In one embodiment, the sealing tape is applied in a single ply, which shortens the process time, wherein an overlap of up to 90 degrees or 25 percent of the casting package circumference is still considered to be a single ply. In another embodiment, the sealing tape is applied in a plurality of layers or in such a way that at least one ply of the sealing tape overlaps at least one other layer of the sealing tape over 90 degrees or over 25 percent of the casting package circumference, preferably at least 180 degrees or at least 50 percent of the casting package circumference, particularly preferably over 360 degrees or 100 percent of the casting package circumference. This can improve the stability and/or sealing.

In one embodiment—in a further development before, in a particularly preferred further development after the application of the sealing tape creating the sealing of the cavity formed between the main or glass body and the mold shell to obtain the casting package—two or more openings are preferably formed in the sealing tape, wherein the cavity is filled with the casting resin through a first of these openings, wherein the cavity is also filled with the casting resin through one or more second of these openings, i.e., the cavity is filled with the casting resin through at least two (inlet) openings, and/or during the filling gas, in particular air, escapes from the cavity through at least a second of these openings, which correspondingly forms an outlet opening. This allows the filling to be improved, in particular to be carried out (more) quickly and/or (more) evenly and/or with a reduced probability of bubble formation.

In one embodiment, the formation of the at least one or of at least one of the opening(s) in the sealing tape takes place after the application of the sealing tape, whereby the opening (in each case) can advantageously be formed particularly precisely and/or easily at the (correspondingly) desired location of the casting package. In one embodiment, the formation of the at least one or of at least one of the opening(s) in the sealing tape is carried out by means of a mechanical opening device or mechanically, in particular by cutting, piercing, punching or the like, whereby the opening (in each case) can advantageously be formed particularly quickly, precisely and/or easily, in particular at a predetermined location of the casting package. In one embodiment, the formation of the at least one or of at least one of the opening(s) in the sealing tape is carried out by means of a thermal opening device or thermally, in a further development by thermal heating or decomposition with a hot object or with an object comprising a hot surface, which is brought into contact with the sealing tape at the desired location to form the opening (in each case), whereby the opening (in each case) can advantageously be formed with a small(er) deformation, in particular at a predetermined location of the casting package. In one embodiment, the formation of the at least one or of at least one of the opening(s) in the sealing tape is carried out by means of laser light, whereby the opening (in each case) can advantageously be formed particularly quickly and/or precisely, in particular at a predetermined location of the casting package.

A further method step S110 can comprise arranging the casting package in a holding apparatus, wherein the casting package is then preferably removed from the holding apparatus in a further method step S116 after the cavity has been filled with the casting resin, preferably after the opening(s) have been closed and after or particularly preferably before the casting package has cured.

A further method step S112 comprises filling the cavity of the casting package with a casting resin. A casting resin can be understood in particular as any composition which, in the liquid or uncured state, comprises a viscosity of up to 800 mPas and/or which, after curing, is suitable for forming a body which is suitable for use as a lens or lens coating. This means in particular that such a casting resin consists of a composition which, already before or in particular after curing, comprises an optical quality with regard to its optical imaging properties which is suitable for use as a lens or lens coating. The method is in particular suitable for the use of higher-viscosity or high-viscosity casting resins. Transparent plastics materials such as poly(thio)urethane, polymethyl methacrylate, polycarbonate, polyacrylate, polydiethylene glycol bisallyl carbonate or combinations thereof can preferably be used as the casting resin. Other components can also be added to such a casting resin, such as components that bring about a desired absorption behavior, such as in particular an increased absorption behavior in the UV range to provide UV protection in the later lens. In addition, components can be added which modify the refractive index of the casting resin, in particular adapting it to the refractive index of the main body, in order to prevent additional light refraction at the interface between the sprue and the main body. Additionally, dyes can be added to obtain a desired color. Depending on the type and nature of the additional components, it can also be necessary to add dyes to conceal a pre-coloring that may be present of the casting resin. If, for example, additional components are added to provide enhanced protection against the transmission of radiation from the ultraviolet and blue spectral ranges by increasing absorption behavior in this spectral range, the resulting targeted removal of radiation, in particular from the visible spectrum, by at least partially removing blue light can result in the light transmitted through the lens no longer being neutral in its color rendering. In such a case, an intrinsic coloration is said to be present, which in the above case would give the lens or lens coating a yellow tint. This can in turn be corrected by adding a blue dye to create a neutral lens coloration. Preferably, the cavity is filled with a casting resin comprising polymers, preferably of polyhydric acrylates and polyhydric methacrylates of high molecular mass, and likewise particularly preferably the cavity is filled with a casting resin comprising polyadducts, in one embodiment (with a casting resin comprising) polymers, preferably of polyhydric acrylates and polyhydric methacrylates of high molecular mass as polyadducts, of polyhydric isocyanates, polyhydric thiols and polyhydric alcohols in combination with photochromic dyes, preferably long-chain substituted as disclosed in WO 2019/238495, the disclosure of which is incorporated into the present disclosure in this regard. Advantageously, by adding photochromic dyes in particular to the casting resin, a casting resin for forming a sprue with photochromic properties can be obtained, which is why this sprue can also be referred to as a photochromic sprue. The casting resins of the polyadducts described above tend to form prepolymers, in particular over longer service lives. In particular with urethane casting resins containing the dyes mentioned above, viscosities are achieved that prevent easy filling.

In one embodiment, the casting resin with which the cavity is filled through the at least one opening or the sprue (on the main body) comprises plastics material, preferably of high optical quality, which is composed of polymerizable molecules, preferably of optical quality, and can in particular consist of such plastics material. These polymerizable compounds in particular can be monomers, oligomers and prepolymers. Preferably, one or more or combinations of the following are used to provide, or as, thermally curable polyurethane and polythiourethane casting resins: multifunctional isocyanates, isothiocyanates and/or episulfides, multifunctional alcohols and/or thiols. Likewise preferably, one or more or combinations of the following are used to provide, or as, thermally and/or photochemically curable polyacrylate and polymethyl methacrylate casting resins: multi- and/or monofunctional acrylates and/or methyl methacrylates. Likewise preferably, one or more or combinations of the following are used to provide, or as, thermally curable polycarbonate and polydiethylene glycol bis(allyl carbonate) casting resins: multi- and/or monofunctional allyl carbonates and/or diethylene glycol bis(allyl carbonates). In addition or as an alternative to these preferred materials, in particular other transparent plastics materials may also be used without restriction.

In one embodiment, a casting resin, preferably a low- or high-viscosity casting resin, is used for filling which comprises a viscosity of up to 800 mPas during the filling and/or in the uncured or liquid state.

In one embodiment, the casting resin (used for filling) comprises one or more, preferably photochromic and/or organic, dyes, particularly preferably one or more photochromic and organic dyes, quite particularly preferably one or more naphthopyran dyes.

The filling of the cavity of the casting package with such a casting resin takes place by means of a device suitable for this purpose, with which a casting resin can be filled through the or one or more of the previously formed (inlet) opening(s) in the sealing tape into the formed cavity located behind the corresponding opening, or that cavity can be filled with a casting resin using such a device.

Preferably, such filling takes place by injecting or filling or dripping the casting resin through the, or one or more of the, filling opening(s) into the cavity of the casting package located behind the filling opening. The cavity formed by the gap between the mold shell and the main body of the casting package is also referred to as a gap or, in particular, as a sprue gap. In one embodiment, the filling with or injecting or filling or dripping of casting resin through the, or one or more of the, filling opening(s) is not carried out through a tube through which the filling opening has been formed and which, after this formation for filling remains at least partially in the corresponding filling opening, i.e., in particular not by injection via a needle that is used to form the corresponding filling opening and subsequently, after this formation, passes through the corresponding filling opening, or the filling opening formed by it, for the filling. Particularly preferably, the filling with or injecting or filling or dripping of casting resin through one or more of the filling openings takes place through at least one tube with at least one channel and the formation of this, or of the corresponding, filling opening(s) is carried out by a device different from this tube, which can in particular also be a needle, possibly a different needle. Further preferably, the formation of the filling opening in the sealing tape, for example by a needle, can be carried out temporally and/or spatially separately from the arrangement of a tube for filling with casting resin. For example, the sealing tape can be provided as a roll with filling openings already formed, in particular with a predetermined spacing.

The casting package can be in any orientation during the filling. Preferably, a casting package is used which comprises exactly two formed openings, of which a first opening functions as an inlet opening and a second opening as an outlet opening. Such a preferred casting package is preferably oriented during filling such that the main body and mold shell are arranged horizontally adjacent, i.e., next to each other along a horizontal axis, and that the casting package is additionally oriented such that the outlet opening is above or higher than the inlet opening in relation to a vertical axis of the casting package. Preferably, the filling takes place in a vertical or perpendicular arrangement, which is understood to mean that the outlet opening is located on the upper side and forms the highest point of the casting package, and the inlet opening is located on the lower side of the casting package and forms the lowest point of the casting package, i.e., the mass flow when filling the casting resin takes place against the direction of gravity. Alternative arrangements are also conceivable and preferred, as long as the filling is carried out in such a way that the mass flow during filling is at least substantially counter to the direction of gravity. In one embodiment, the cavity is filled under excess pressure, in particular compared to ambient (air) pressure, and/or at least partially against the direction of gravity. Alternatively, the casting package can also be in a horizontal position during filling, which is understood as meaning that the casting package is in a position and orientation in which the main body is above the mold shell or in which the mold shell is above the main body. In such a case, filling preferably takes place through a plurality of openings, in particular simultaneously. Conveniently, the casting package is arranged in a holding apparatus in order to keep the first and second openings oriented in accordance with a desired positioning. The casting package is preferably arranged in the holding apparatus before the casting resin is filled and can be removed from the holding device after the filling, in particular after curing. By filling under overpressure, filling at least partially against the direction of gravity and quite particularly filling under overpressure and at least partially against the direction of gravity, the filling can be improved, in particular carried out (more) quickly and/or (more) evenly and/or with a reduced probability of bubble formation.

It is understood that a device can be provided which is suitable for forming the, or one or more of the, opening(s) in a sealing tape of a casting package or for evacuating a cavity of a casting package as well as for filling a casting package with a casting resin and for closing a formed opening in a casting package. This device can advantageously comprise means for piercing the sealing tape and for filling, for example a sharp-edged hollow needle. However, hollow needles can tend to cause pressure loss when closing a formed opening in a casting package, restrict the volume flow, and promote the escape of casting resin. Therefore, as already mentioned, it is particularly preferred to use one or more single- or multi-channel tubes, in particular hollow needles, which connect to or pass through the corresponding opening(s) for filling the casting package with casting resin through one or more (of the filling) opening(s) in a sealing tape of a casting package, and to use a device different from this/these tubes for forming this/these opening(s), wherein this device can be similarly arranged with the tube(s) on a common, in particular movable, carrier in order in this way to preferably realize the formation of the opening(s) and filling promptly and/or with few(er) adjustments, or can be actuated separately from the tube(s), in order in this way to preferably simplify the device and/or adjustment. Particularly preferably, a sealing element, preferably overlying sealing element, is designed to fluidically seal the puncture point.

In a particularly preferred embodiment, filling the cavity comprises filling the cavity with the casting resin from a casting resin reservoir, through a single- or multi-channel supply line, a molded part which is preferably sealing with respect to the casting resin and which during filling rests on the casting package at least temporarily, preferably with a contact face, and the or one or more of the (inlet) opening(s). In one embodiment, the molded part comprises at least one elastic layer for contacting or resting on the casting package(s), can in particular consist of an elastic and correspondingly conformable material, in particular the elastic layer or the elastic material can comprise or form the contact face of the molded part.

In one embodiment, the molded part and the casting package are pressed against one another, in an advantageous further development with a defined and/or adjustable or adjusted contact pressure and/or by means of a one-part or multi-part pressing device, which in one embodiment comprises, in particular can be, a preferably mechanical, hydraulic or pneumatic, one-part or multi-part spring mechanism and/or a one-part or multi-part mechanical guide that is preferably adjustable, preferably adjustable in a motor-driven, hydraulic or pneumatic manner, in one embodiment in a robotic manner.

An elasticity or compliance for effecting the preferably defined and/or adjustable or set contact pressure can be formed or provided in particular by an elasticity or compliance of the casting package, in particular of the sealing tape, and/or particularly advantageously by an elasticity or compliance of the molded part, in particular of the elastic layer(s) or the elastic material, and/or, likewise particularly advantageously, by the spring mechanism.

Accordingly, in one embodiment, the molded part and the casting package are pressed against one another by appropriately positioning the molded part relative to the casting package, preferably by the mechanical guide, and/or positioning the casting package relative to the molded part, preferably by the mechanical guide, and/or with compression of the casting package and/or, particularly advantageously, the spring mechanism and/or the molded part.

In one embodiment, the mechanical guide is adjusted manually or by at least one, preferably electric-motor-driven, hydraulic or pneumatic, actuator. In one embodiment, the mechanical guide comprises a preferably adjustable and/or friction- and/or positive-fitting fixing for fixing the molded part relative to the casting package and/or fixing the casting package relative to the molded part.

In one embodiment, the molded part is movable in a pre-tensioning direction and the casting package is firmly or rigidly supported in the pre-tensioning direction, wherein the molded part is pressed against the casting package in the pre-tensioning direction by the pressing device, in a further development a preferably mechanical, hydraulic or pneumatic spring mechanism and/or mechanical guide that is preferably adjustable in a motor-driven, hydraulic or pneumatic manner, in one embodiment in a robotic manner. This allows a particularly advantageous mounting of the casting package to be realized.

In another embodiment, conversely, the casting package is movable in a pre-tensioning direction and the molded part is firmly or rigidly supported in the pre-tensioning direction, wherein the casting package is pressed against the molded part in the pre-tensioning direction by the pressing device, in a further development a preferably mechanical, hydraulic or pneumatic spring mechanism and/or a mechanical guide that is adjustable in a preferably motor-driven, hydraulic or pneumatic manner, in one embodiment in a robotic manner. In this way, a particularly advantageous supply of casting resin can be realized.

In a further embodiment, the molded part is movable in a pre-tensioning direction and the casting package is also movable in the pre-tensioning direction, wherein the molded part is pressed against the casting package in the pre-tensioning direction by the pressing device, in a further development a (partial) spring mechanism, which is preferably mechanical, hydraulic or pneumatic, and/or a mechanical (partial) guide that is preferably adjustable in a motor-driven, hydraulic, or pneumatic manner, in one embodiment in a robotic manner, and the casting package is pressed against the molded part in the pre-tensioning direction by the pressing device, in a further development a (partial) spring mechanism, which is preferably mechanical, hydraulic or pneumatic, and/or a mechanical (partial) guide that is preferably adjustable in a motor-driven, hydraulic or pneumatic manner, in one embodiment in a robotic manner. For example, the casting package can be compliantly supported by a (partial) spring mechanism and the molded part can be pressed against the casting package, or vice versa, by a mechanical guide that is adjustable in a motor-driven, hydraulic or pneumatic manner, in one embodiment in a robotic manner, and/or a (partial) spring mechanism. In this way, a particularly advantageous filling and/or sealing can be realized.

A (partial) spring mechanism mentioned here preferably comprises one or more mechanical, hydraulic or pneumatic compression springs. A mechanical guide mentioned here can be adjusted or adjustable by a single-axis or multi-axis robot, in particular a robot arm, or the like, wherein a multi-axis robot (arm) is understood to mean a one-, two-, three- or multi-axis manipulator for displacement in one, two or three spatial directions and/or rotation about one, two or three spatial directions. Accordingly, in one embodiment, a device for carrying out a method described here, in a further development the pressing device, comprises such a single-axis or multi-axis manipulator or robot, in particular, the molded part can, if necessary initially, be moved towards the casting package and/or can, if necessary subsequently, be pressed against the firmly supported or compliantly mounted casting package with a defined and/or adjustable or adjusted contact pressure by the mechanical guide that is adjustable in a motor-driven, hydraulic or pneumatic manner by means of the manipulator or robot. Likewise, for example the molded part can be positioned manually relative to the casting package or the casting package can be positioned manually relative to the molded part and fixed in this position by the mechanical guide, wherein the molded part and the casting package are pressed against one another with a defined contact pressure by compression of the casting package and/or, particularly preferably, of the correspondingly elastic molded part and/or a spring mechanism which may be additionally provided.

By means of one or more of the above-mentioned features or embodiments, in particular the molded part and preferably the pressing device, a better seal can be achieved compared a channel introduced into the cavity, in particular a cannula or the like introduced through the sealing tape or (one of) its (inlet) opening(s). The combination of the pressing described above with the formation of at least one opening in the sealing tape after the application of the sealing tape by means of an opening device is particularly advantageous, since in this way these opening(s) can be optimally sealed.

In one embodiment, the molded part or its contact face comprises at least one opening, in particular an outlet opening, preferably a through-opening, which at least during filling (in the flow direction of the casting resin) directly adjoins the, or at least one of the, (inlet) opening(s) in the sealing tape. The molded part can be formed in one or more parts, wherein the molded part or one or more of its parts can (each) have one or more such openings. In this case, an assignment can be particularly advantageous in which a (separate) opening of the molded part or of its contact face, which may be multi-part, is directly connected to the, or to each of the, inlet opening(s) in the sealing tape. In this way, a particularly advantageous sealing and/or filling can be realized. Likewise, the, or at least one of the, opening(s) of the molded part can connect to two or more (inlet) openings in the sealing tape, or these (inlet) openings can be supplied or flowed through by the same opening of the molded part or its contact face. In this way, the construction and/or positioning of the molded part can be simplified.

In one embodiment, an edge of, or an edge of at least one of, the opening(s) of the molded part or its contact face (each) completely surrounds or encloses or encompasses an edge of the adjoining (inlet) opening(s) in the sealing tape. In this way, a particularly advantageous sealing and/or filling can be realized. In one embodiment, an edge of, or an edge of at least one of, the (inlet) opening(s) in the sealing tape (each) completely surrounds or encloses or encompasses an edge of the adjoining opening(s) of the molded part or of its contact face. In this way, the construction and/or positioning of the molded part can be simplified.

In one embodiment, the molded part and/or the opening device is displaced relative to the casting package arranged in the holding apparatus by means of a, or the, mechanical guide. In this way, the filling or formation of the opening(s) can be improved.

In one embodiment, the cavity is evacuated before filling, in a further development by means of the opening device or the molded part lying on it, which for this purpose can first be connected to a suction pump and then switched to the casting resin reservoir.

In one embodiment, the casting resin reservoir can comprise a pressure device for filling the cavity under overpressure (relative to the ambient (air) pressure). In this way, a particularly advantageous filling can be realized.

In a further method step S114, after filling has been completed the existing opening or, if there are a plurality of openings, all existing openings in the sealing tape can be closed. This includes all conceivable means which result in the existing opening(s) being subsequently closed, such as in particular the new application of a further ply of a sealing tape, preferably a further ply of the sealing tape already applied in a previous step. Alternatively, the openings can also be closed by prepolymerization induced in a targeted manner, or by gelling of the filled casting resin, either caused by thermal energy, for example by a focused laser pulse, or by photochemical reaction by targeted irradiation with electromagnetic radiation of a suitable wavelength that causes prepolymerization, such as a UV laser pulse. In this way, a first curing or gelling takes place in such a way that the casting resin cannot escape through one of the openings of the casting package when the casting package is transferred to a curing device. This is to be avoided in particular because such casting resins often consist of isocyanates that are harmful to health and that should not come into direct contact with production personnel at any time. In addition, such escaping casting resin can also lead to irreversible contamination or damage to the main body, so that it must be discarded. Accordingly, in one embodiment, the casting package is removed from the holding apparatus in a further method step S116 and is preferably transferred to a curing device for, if necessary, further or complete curing.

In a further method step S118, the casting package can be cured, in particular completely, which is understood in particular to mean that a curing process is initiated which leads to the filled casting resin being converted into a solid state. Depending on the type and nature of the casting resin or the components forming the casting resin, such a curing process can take place either thermally or photochemically, or as a combination of both. Accordingly, in one embodiment the curing of the casting package comprises thermal and/or photochemical and/or complete curing of the casting package. For thermal curing, the casting package is cured in a kiln as the preferred thermal curing device, wherein the casting package remains in this kiln at a temperature and for a duration suitable for curing the casting resin used. For photochemical curing, the casting package is cured in a device comprising at least one receptacle suitable for receiving the casting package and a radiation source suitable for emitting electromagnetic radiation of a wavelength suitable for curing the casting resin. In such a photochemical curing device, the casting package is irradiated with radiation emitted from the radiation source of a certain wavelength and energy or energy density for a predetermined duration in order to achieve curing of the casting resin.

In a further method step, the casting package is removed from the curing device after curing has been completed. The sealing tape is removed in a further method step S120. This preferably means detaching the sealing tape, which can be done by a suitable device.

In a further method step S122, the casting package is demolded, which is understood as removing the mold shell. After removing the mold shell, a lens is obtained, formed from a main body provided with a sprue, an overlay, a layer, or a coating. The lens produced in this way can also be referred to as a multi-ply lens or, in particular, as a two-ply lens.

As already emphasized, one or more of the aforementioned (further) method steps can also be omitted, for example the formation of at least one opening in the sealing tape, the closing of the opening and/or the curing of the casting package.

Preferably, the improvement of the inflow behavior of the casting resin is provided by a suitable widening of the sprue gap at least at the inlet opening. This can preferably be done via a mold shell which comprises a slightly different edge geometry, preferably realized as a facet, at least in a region around the inlet opening. Due to this faceting of the mold shell, the distance between the mold shell and the main body is slightly increased in the region of the inlet opening, which results in an enlarged gap or the formation of a small chamber behind the inlet opening. This ensures a turbulence-free inflow of the casting resin during filling, which results in reduced streaking and fewer gas inclusions. In a further embodiment, the widening of the sprue gap can also be achieved by providing a correspondingly adapted geometry of the main body in the region of the inlet opening instead of the faceting of the mold shell, which is preferably achieved as faceting of the main body, at least in the region of the inlet opening. Alternatively or additionally, a widening of the sprue gap can be realized by both the mold shell and the main body having a widening; preferably, both the mold shell and the main body have such a faceting. The faceting discussed in the various embodiments is present at least at the location of the inlet opening, but can also be realized circumferentially and can thus extend to the entire mold shell or to the entire main body. Advantageously, such a widening prevents turbulence and convection of the casting resin, thereby preventing the occurrence of casting streaks, inhomogeneities and the resulting locally altered optical properties of the sprue. In addition to improving the inflow of the casting resin, the widening of the sprue gap also makes it easier to install large diameter inlet openings. In combination with the sealing filling device, in this way high volume flows can be achieved, in particular even with higher-viscosity casting resins.

In one embodiment, the cavity formed comprises a gap widening or local enlargement of the gap width in a region around the or one or more of the opening(s) in the sealing tape, wherein the gap width at a point in the cavity can in particular be the shortest distance between the mutually facing surfaces of the main body and the mold shell at this point in the cavity. In a further development, the main body, or preferably the mold shell and the main body (each), or particularly preferably the mold shell alone, comprises a continuous, preferably linear, receding of the cavity-delimiting surface at least in one portion of the gap widening.

By forming the gap widening by appropriate shaping of the mold shell, the gap widening can be realized particularly advantageously, in particular (more) easily, and advantageously a shaping of the main body can be avoided that influences its optical properties and/or usable region and/or further processing and/or is (more) complex to produce than on the mold shell. By means of a continuous, preferably linear, receding of the cavity-delimiting surface, a particularly advantageous filling or casting resin flow can be achieved and/or the gap widening can be produced particularly easily and/or reliably.

In one embodiment, the gap widening extends over the entire circumference of the cavity. In this way, a particularly advantageous filling or casting resin flow can be effected.

In one embodiment, at least one main body edge delimiting the gap widening is removed from the resulting lens, in a further development by removing material or separating it. As a result, the shape of the main body intended for advantageous filling or (co-)formation of the gap widening does not impair the finished lens.

In one embodiment, one or more parameters of the method, in a further development at least one parameter of the filling of the cavity through the at least one opening with the casting resin, preferably a pressure during filling or the like, are set as a function of a viscosity of the casting resin, in a further development adjusted, preferably (re)regulated, during the execution of the (corresponding) method (step). In particular, an increase in viscosity over the service life can be at least partially compensated for by, for example, accordingly increasing the pressure during filling.

One aspect relates to a lens produced by the inventive method or to glasses or contact lenses provided with at least one such a lens. It is understood that the use of such a lens is not limited to ophthalmic optics or contact lenses, but can also be used in other optical lenses in the fields of photography, projection, microscopy, lighting, for example in mobile devices, headlights, optical measuring instruments, etc.

One aspect relates to a or the device for carrying out an inventive method, which accordingly comprises one or more of the following devices:
a, or the, opening device for forming the at least one opening in the sealing tape,
a, or the, holding apparatus for arranging and removing the casting package,
a, or the, casting resin reservoir, a, or the, supply line, and a, or the, sealing molded part for filling the cavity with the casting resin through the at least one opening, in a further development a, or the, pressing device for pressing the molded part and casting package against one another,
a, or the, device for closing the at least one opening, and
a, or the, curing device for curing the casting package.

One aspect relates to a, or the, casting package, in particular a or the casting package obtained by an inventive method or used in an inventive method, which package comprises at least:
a, or the, main body,
a, or the, mold shell, and
a, or the, sealing tape,
wherein the empty cavity or the cavity filled with the, in particular cured, casting resin is formed between the main or glass body and the mold shell.

In one embodiment, one or more, in particular all, steps of the method are carried out completely or partially automatically, in particular with the aid of the device.

Further advantages and features are apparent from the exemplary embodiments or preferred embodiments described below.

### BRIEF DESCRIPTION OF THE DRAWINGS

The accompanying drawings, which are incorporated in and constitute a part of this specification, illustrate exemplary embodiments of the invention and, together with a general description of the invention given above, and the detailed description given below, serve to explain the principles of the invention.

FIG. 1 is a schematic drawing of an embodiment of a casting package 1 in a frontal view, in which the mold shell 11 and the main body 10 are arranged one behind the other in the viewing direction, with the filling device 2 in place;

FIG. 2 depicts a sectional view of FIG. 1 taken along the axis A;

FIG. 3 depicts an enlarged view of the region Z from FIG. 2 with three different embodiments for realizing a widening 5 (5a, 5b, 5c) of the sprue gap;

FIG. 4 illustrates an embodiment of a device for forming an opening in a sealing tape of a casting package;

FIG. 5 illustrates a method according to one embodiment of the present invention; and

FIGS. 6-8 show various diagrams of viscosity and photochromism.

### DETAILED DESCRIPTION

In the different figures, identical reference signs represent the same elements in each case.

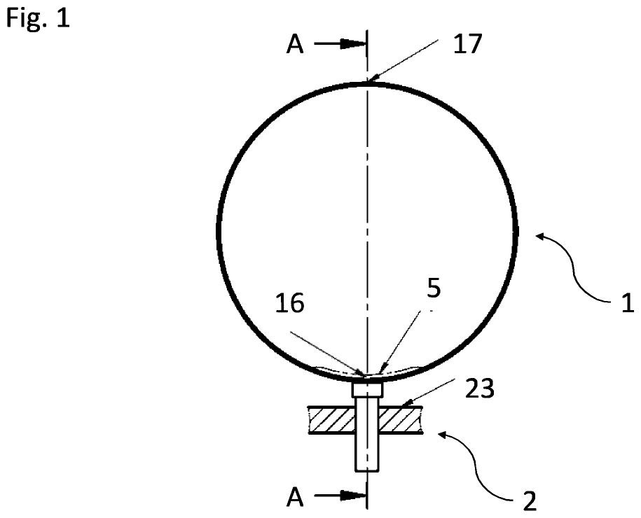

FIG. 1 is a schematic drawing of a casting package 1 in a frontal view in accordance with the principles of the disclosure. The mold shell or front casting mold 11 forming the casting package and the main body, in the exemplary embodiment a plastics material base glass 10, are arranged one behind the other and are therefore not shown. An axis A has been drawn along the vertical axis of the casting package 1.

In accordance with a preferred embodiment, the casting package 1 comprises a widening 5 of the sprue gap in the region of the inlet opening 16, and an outlet opening 17. In modifications not shown, the outlet opening 17 may be omitted or more than one outlet opening may be provided, more than (the) one inlet opening 16 may be provided, inlet and/or outlet opening(s) can be positioned differently and/or the widening 5 may be shaped differently, in a particularly preferred modification can extend over the entire circumference or 360 degrees.

In addition, FIG. 1 shows a filling device 2 which has been arranged at the inlet opening 16. In one embodiment, the filling device 2 comprises an element 23 for mechanical guidance, with which the filling device 2 the filling device 2 can be arranged precisely at the inlet opening 16 by means of a robot arm as a preferred mechanical guidance means, in particular by connecting the robot arm to the mechanical guide 23 of the filling device 2.

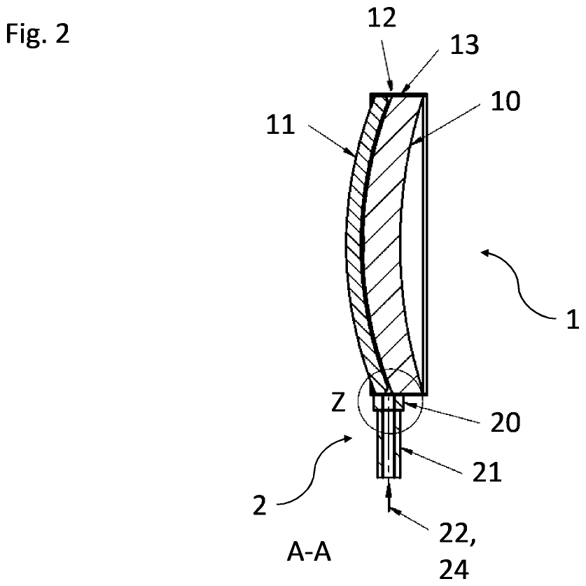

FIG. 2 shows a sectional view of FIG. 1 along the A-A axis. The casting package 1 comprises a main body 10 and a mold shell 11, wherein the main body 10 and the mold shell 11 are positioned relative to one another in such a way that a cavity 12 is formed between the main body 10 and the mold shell 11, which cavity can be filled with a casting resin. The main body 10 and the mold shell 11, as well as the cavity 12 located between the two, are sealed or closed with a sealing tape 13, preferably circumferentially, in a gas- and liquid-tight manner. In the embodiment shown here, a filling device 2 is arranged below the casting package, comprising a supporting and sealing molded part 20, which is preferably made of an elastic and conformable material in order to enable a precisely fitting arrangement of the filling device 2 on the casting package 1. Preferably, the material of the sealing molded part 20 is selected such that it comprises a high chemical resistance to the casting resins used. The filling device 2 further comprises a supply line 21 through which the casting resin can be fed from a casting resin reservoir 24 into the cavity 12 of the casting package 1 during the filling process. In a preferred embodiment, the filling device 2, in one embodiment the casting resin reservoir 24, comprises a pressure device 22. By means of this pressure device 22, on the one hand the cavity 12 can be evacuated before filling in order to additionally form a pressure equalization opening 17, which is understood to mean the formation of an outlet opening 17 for the escape of the air displaced during filling and located in the cavity. Furthermore, the pressure device 22 is also suitable for filling the cavity 12 with a casting resin under a predetermined pressure. Advantageously, the filling of the cavity 12 with a casting resin can take place under an increased pressure, whereby a shorter duration of the filling process is achieved, in particular when using high-viscosity casting resins.

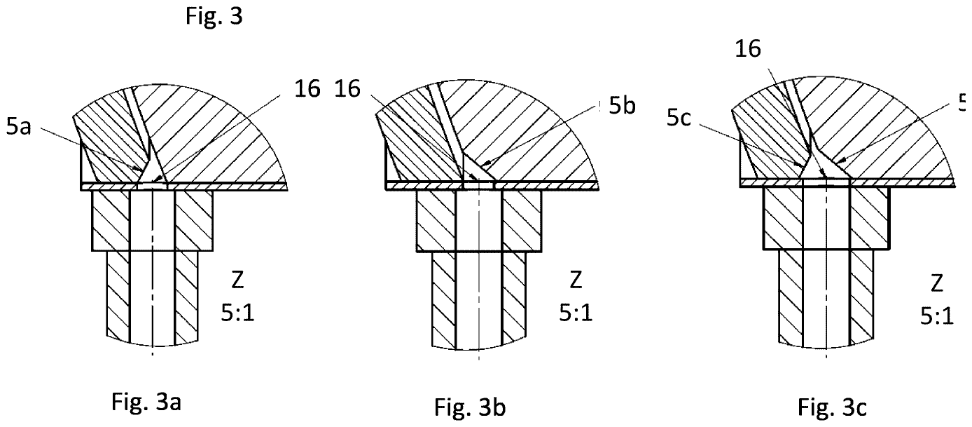

FIG. 3 shows an enlarged view of the region Z from FIG. 2 for three different embodiments. In these embodiments, the region behind the inlet opening 16 comprises a widening 5 in each case (5a, 5b, 5c), in particular a widening of the sprue gap, which is realized in different ways and improves the inflow behavior of the casting resin during filling with a filling device 2. Advantageously, the widening 5 (5a, 5b, 5c) of the sprue gap leads to a lower tendency of turbulence when filling the cavity 12 of the casting package 1 with a casting resin, thereby avoiding the occurrence of streaking and gas inclusions. FIG. 3a schematically shows an embodiment in which a widening 5a of the sprue gap is achieved by the mold shell comprising a faceting, at least in the region of the inlet opening 16. In FIG. 3b, a further embodiment is shown schematically in which the widening 5b of the sprue gap is achieved by faceting the main body, at least in the region of the inlet opening 16. FIG. 3c shows a combined embodiment in which a widening 5c of the sprue gap was realized by faceting both the mold shell and the main body, at least in the region of the inlet opening 16. As already explained, the widening 5 can be shaped differently in a modification not shown, and in a particularly preferred modification can extend over the entire circumference, or 360 degrees. In addition to improving the inflow of the casting resin, the widening of the sprue gap also makes it easier to install large diameter inlet openings. In combination with the sealing filling device 2, in this way high volume flows can be achieved, in particular even with higher-viscosity casting resins.

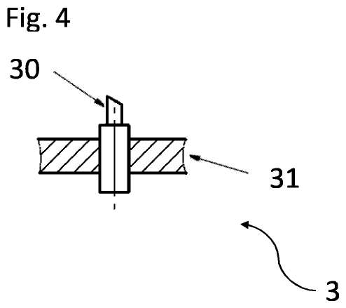

FIG. 4 shows an embodiment of an opening device 3 for forming openings (16, 17) in a sealing tape 13 of a casting package 1. The opening device comprises an element 30 suitable for forming an opening (16, 17). This can preferably be understood as a mechanical component with a pointed or sharp-edged border or shape, which is suitable for forming an opening (16, 17) in a sealing tape 13 of a casting package 1, which is preferably understood as cutting or punching or perforating. In a preferred embodiment, the element 30 is a sharp knife blade with which an opening (16, 17) can be cut into a sealing tape 13 of a casting mold 1. Alternatively, the element 30 for forming an opening (16, 17) can also be an element with a heated surface, which, by being directly arranged on or contacting a sealing tape 13 of a casting package 1, leads to thermal heating or thermal decomposition of the sealing tape 13 at the contact point, whereby an opening (16, 17) is formed. Alternatively, the element 30 can also be a radiation source, in particular a source of pulsed laser radiation, with which, by applying one or more laser pulses, thermal heating or thermal decomposition of a sealing tape 13 at a contact point leads to the formation of an opening (16, 17). Advantageously, when a laser source is used as the preferred element 30 for forming an opening, the opening device 3 does not have to be brought into direct or immediate contact with a sealing tape 13 of a casting package 1, but can be positioned at a distance therefrom. The opening device 3 can additionally comprise an element 31 for mechanical guidance, with which the opening device 3 the opening device 3 can be arranged precisely at the inlet opening 16 by means of a robot arm as preferred mechanical guidance means, in particular by connecting the robot arm to the mechanical guide 31 of the opening device 3.

Using the robotically guided mechanical guide 23, the molded part 20 can advantageously be pressed against the casting package with a defined, adjustable, or set contact pressure. Additionally or alternatively, a spring mechanism can also be provided which presses the molded part against the casting package and/or the casting package against the molded part; accordingly, the element 23 indicated in FIG. 1 can also represent or comprise such a (partial) spring mechanism. The mechanical guide 23 can also comprise, in particular be, a fixing of the molded part 20 relative to the casting package arranged in the holding apparatus, wherein the contact pressure can preferably be imposed by compression of the correspondingly elastic molded part 20 and/or a spring mechanism.

The embodiments and examples explained above disclose an inventive filling process for casting a thin photochromic layer on a plastics material base glass 10, which advantageously allows filling of the casting package without leaks and uncontrolled escape of casting resins.

For this purpose, a filling device or system 2 is provided which rests on the edge of the casting package 1 consisting of the front casting mold 11, the plastics material base glass 10 and the circumferential sealing tape 13. This filling device or system comprises an elastic molded part 20 resting on the sealing tape 13, which molded part comprises a high chemical resistance to the casting resin used, a feed or supply line 21 of the casting resin, a pressure device 22 and a mechanical guide 23 for adjusting or pressing on the molded part.

For creating a filling opening in the sealing tape, an apparatus or opening device 3 is provided, comprising a tool 30 which cuts an opening of a defined size into the sealing tape material and in doing so does not damage the mold shell and the base glass, or in another example, produces the filling opening by thermal decomposition of the sealing tape material. Furthermore, the apparatus comprises a mechanical device 31 which positions the filling opening so that it is subsequently enclosed by the sealing molded part 20 of the filling system. The large-diameter opening thus produced allows filling with an optimized cross section.

In order to improve the inflow behavior of the casting resin to avoid casting streaks and gas inclusions, in addition to the use of the filling system 2 the mold shell and/or the main body of the casting package are adapted to the process requirements and to the positioning of the adapted casting package in relation to the filling opening and the elastic molded part. When the molded part is pressed on, there is a widening 5 of the sprue gap behind the filling opening, which widening is shaped in such a way that a low-turbulence inflow of the casting resin can be achieved. The recesses can be designed in various geometries that meet the above-mentioned requirements: a possible, non-limiting inventive embodiment is, for example, a chamfer on the edge of the casting package. The widening 5 of the sprue gap can advantageously be provided by a recess in the front-side casting mold 5a, particularly advantageously a linear receding of the cavity-delimiting surface of the front-side casting mold, a recess in the base glass 5b, preferably a linear receding of the cavity-delimiting surface of the base glass, or by oppositely situated recesses in the casting mold and base glass 5c, advantageously linear recedings of the oppositely situated cavity-delimiting surfaces. The widening of the sprue gap is provided at least in the region of the filling opening, but is not limited to this edge segment. As already mentioned, in a further embodiment (not shown) the widening of the sprue gap, in particular the recess 5a, 5b or 5c, is circumferential. The radial extent of the widening is preferably a few mm to avoid material loss.

The filling can be carried out in different casting package positions, preferably it is carried out in a tilted or upright position and orientation on the lower circular arc segment facing the filling opening. At least one opening in the sealing tape for pressure equalization during filling is provided at an oppositely situated position.

In one embodiment, an inventive filling process is carried out as follows: a casting package with optimized geometry of the components (5a/5b/5c) and a small gap dimension is provided. The casting package is positioned as described and is perforated by the apparatus with the opening tool 30, on the sealing tape. Enclosing the filling opening, the elastic molded part 20 presses on the sealing tape. Under pressure, the photochromic acrylate or (thio)urethane casting resin is injected for a short duration via the widened circular ring or annular portion of the casting package. After filling is complete, the pressure equalization openings and then the filling opening are closed. The casting package can be removed and subjected to thermal or photochemical curing. After the photochromic sprue has cured, the upper mold shell is removed and, in a subsequent step, the product thus produced is machined to the desired diameter as required. In this way, an inventive raw round ophthalmic lens is obtained having very good cosmetic quality with the desired photochromic properties in a fast production process.

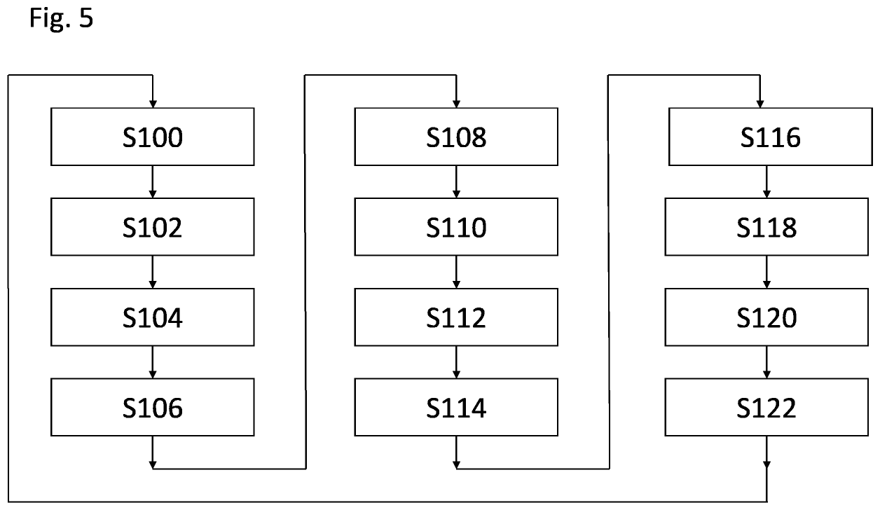

FIG. 5 shows a method according to an embodiment of the present invention, having the following steps:
S100: providing a main body,
S102: providing a mold shell,
S104: arranging the main or glass body and the mold shell in such a way that a cavity is formed between the main or glass body and the mold shell,
S106: applying a sealing tape to seal the cavity formed between the main or glass body and the mold shell to obtain a casting package,
S108: forming at least one opening in the sealing tape,
S110: arranging the casting package in a holding apparatus,
S112: filling the cavity with a casting resin through the at least one opening,
S114: closing the opening,
S116: removing the casting package filled with a casting resin from the holding apparatus,
S118: curing the casting package,
S120: removing the sealing tape, and
S122: removing the mold shell to obtain a lens.

In the following, concrete examples of photochromic lenses are presented which have a sprue made of poly(thio)urethane casting resin with high-viscosity fused naphthopyran dyes, or the sprue was carried out or produced in each case by filling the cavity of the casting package through at least one opening with a poly(thio)urethane casting resin with high-viscosity fused naphthopyran dyes or an inventive (sprue) method using a seal, a main body, a mold shell and a gap widening in the region of the (filling) opening.

The method is particularly advantageous for all thermally or photochemically curing polymer casting resins. In particular, it can be used for polyurethanes, polythiourethanes and mixed forms, for thermally and photochemically curable polyacrylates, polymethyl methacrylates and their mixed forms, and for thermally curable polycarbonates. Polyurethanes and polythiourethanes as well as their mixed forms are produced by polyaddition from corresponding monomers. The step growth of the polyaddition reaction can lead to rapid viscosity increase after mixing of the casting resin.

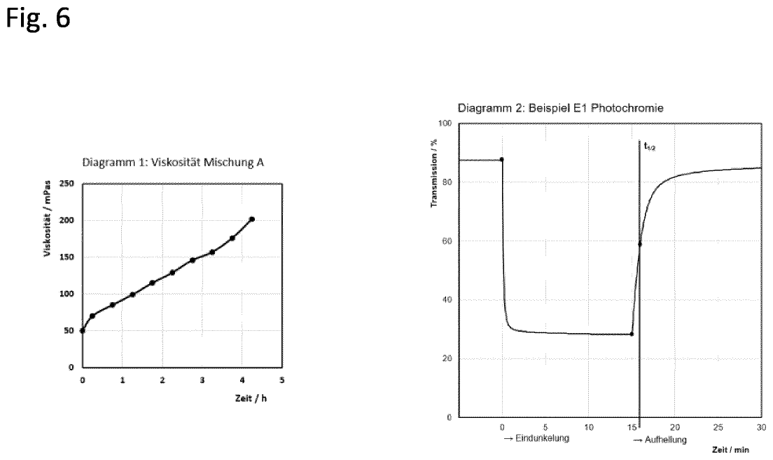

The following Table 1 and Diagram 1 (FIG. 6) show, by way of example, the viscosity profile of a casting resin mixture A (composition of Example E0; see Table 2), which was stirred under laboratory conditions after preparation and subsequent evacuation (3×10⁻¹ mbar). The viscosity measurements were determined from samples taken from the casting resin mixtures, using viscometers. Rotavisc LO-VI (IKA) and Visconorm DD (Gel Instrumente) were used.

TABLE 1
Example of the viscosity of a photochromic poly(thio)urethane
casting resin Casting resin mixture see Table 2

| E0 | Time | Viscosity | Temperature |
|---|---|---|---|
| Mixture A | t [h] | [mPas] | [° C.] |
| after evacuation | 0.00 h | 50 mPas | 21.0 |
| Stirring | 0.25 hours | 70 mPas | 22.6 |
| | 0.75 hours | 85 mPas | 21.2 |
| | 1.25 hours | 99 mPas | 21.7 |
| | 1.75 hours | 115 mPas | 21.1 |
| | 2.25 hours | 129 mPas | 20.9 |
| | 2.75 hours | 146 mPas | 21.0 |
| | 3.25 hours | 157 mPas | 21.2 |
| | 3.75 hours | 176 mPas | 21.1 |
| | 4.25 hours | 202 mPas | 21.0 |

Table 2 shows various examples of a sprue or a casting resin for filling the cavity of the casting package in an inventive (sprue) method or an inventive casting package or an inventive(ly produced) lens:

TABLE 2
Inventive examples of sprue variants on main body MR8 with refractive index n 1.595

| | | | | | | | | Polythiol-polyol |
|---|---|---|---|---|---|---|---|---|
| | | | Service | | Isocyanate-dye mixture | | | mixture |
| | | Viscosity | life of | | | Polyether | Isocyanate | Polythiol |
| | | of the | the | Sprue | | units in | component | component |
| Inventive | Main | sprue | mixture | thickness | Photochromic | the dye | (MR8) | A (MR8) |
| example | body | mPas | h | μm | color mixing | P | [%] | [%] |
| (E0) | — | Table 1 | Table 1 | — | Mixture A | >15 | 50 | 25 |
| | | | | | (Formula 2) | | | |
| E1 | MR8 | 98 | 1.5 | 500 | Dye A | >40 | 50 | 33 |
| | | | | | (Formula 1) | | | |
| E2 | MR8 | 47 | 1.0 | 250 | Mixture B | approx. | 51 | 25 |
| | | | (Table 3) | | | 15 | | |
| E3 | | 135 | 6.0 | 250 | (Formula 2) | | 51 | 25 |
| | | | (Tab. 3) | | | | | |
| E4 | MR8 | 156 | 2.5 | 318 | Dye B | approx. | 49 | 32 |
| | | | | | (Formula 2) | 15 | | |
| | | | | | Other | | | |
| | Polythiol-polyol | | | | Releasers, | | | |
| | mixture | | | | UV | Photochromism | | |
| | Polythiol | Polyol | | Adhesion | blockers, | | t_{1/2} | |
| | component | components | Catalyst | promoter | additives, | Tₛ | Half- | |
| Inventive | B (MR8) | C | DMTDC | Epoxy | etc. | Darkening | life | |
| example | [%] | [%] | ppm | [%] | [%] | [% T] | min | Diagram |
| (E0) | 20 | 4 | 800 | — | 1 | — | — | — |
| E1 | 17 | — | 400 | — | — | 28.2% Tₛ | 0.90 | Dia. 1 |
| | | | | | | | min | |
| E2 | 20 | 3 | 500 | — | 1 | 8.0% Tₛ | 2.32 | Dia. 2 |
| | | | | | | | min | |
| E3 | 20 | 3 | 500 | — | 1 | 8.0% Tₛ | 2.34 | Dia. 2 |
| | | | | | | | min | |
| E4 | 16 | 2 | 500 | 0.5 | 0.5 | 8.6% Tₛ | 1.43 | Dia. 3 |
| | | | | | | | min | |

In the examples, casting resin mixtures with MR8 components (Mitsui Chemicals) were chosen as the material for the MR8 main body, although comparative tests showed that other main body materials also lead to advantageous results. The sample lenses produced in these and other test series were tested for their photochromic properties. The measurement at 23° C. is carried out in accordance with DIN EN ISO 8980-3:2022 on a special measuring setup equipped with diode array spectrometers MCS 551 Vis (Carl Zeiss Spectroscopy) and xenon arc lamp LSH 201 (L.O.T.) with 300 W Xe OF ilIuminant (Ushio) for excitation. Maximum darkening Tol after 15 min excitation and half-life of the brightening of τᵥ₁ after τᵥ₀ (non-excited state) are listed in Table 2.

In the casting resin mixture for Example E1, a fused 2H-naphthopyran was used as photochromic dye A in accordance with the following formula 1. In accordance with formula 1, the dye carries an N-morpholinyl group as substituent R1 and is substituted with a linear polypropylenoxy chain via a succinic acid ester bridge. The long length of p>40 units and the use of polypropylenoxy units allow incorporation into the monomer mixture of the thiourethane casting resin and obtaining of good photochromic properties:

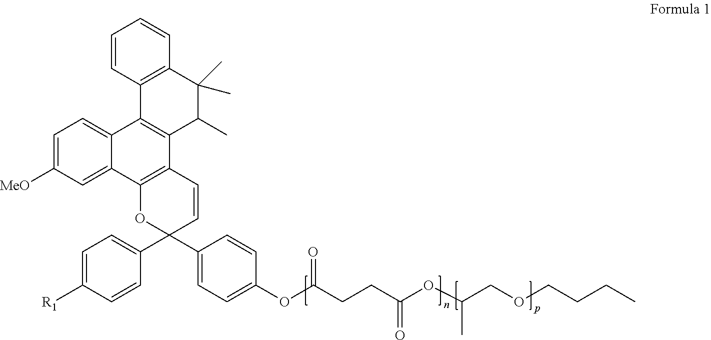

For the preparation of dye mixture A for viscosity tests E0 as well as for the preparation of Examples E2 (mixture B), E3 (mixture B) and E4 (dye B), in each case dyes from the group of indenonaphthopyrans in accordance with formula 2 are used. These dyes are disclosed in particular in WO 2019/238495.

The dyes carry linear polypropylenoxy chains with p≥10 in accordance with formula 2. The radicals R₁, R₂ and R₃ each independently of one another represent a substituent selected from hydrogen, bromine, chlorine, fluorine, a (C₁-C₆)-alkyl radical, a (C₃-C₇)-cycloalkyl radical, a (C₁-C₆)-thioalkyl radical, a (C₁-C₆)-alkoxy radical, a hydroxy radical, a tert-butyl-dimethylsilyloxy radical, a tert-butyl-diphenylsilyloxy radical, a trifluoromethyl radical, a phenyl radical, a phenoxy radical, a benzyl radical, a benzyloxy radical, a biphenyl radical, a biphenyloxy radical, a naphthyl radical, a naphthoxy radical, a mono-(C₁-C₆)-alkylamino radical, a di-(C₁-C₆)-alkylamino radical, a phenylamino radical, a diphenylamino radical, a piperidinyl radical, a 3,5-dimethylpiperidinyl radical, an indolinyl radical, a morpholinyl radical, a 2,6-dimethylmorpholinyl radical, a thiomorpholinyl radical, an azacycloheptyl radical, a phenothiazinyl radical, a phenoxazinyl radical, a 1,2,3,4-tetrahydroquinolinyl radical, a 1,2,3,4-tetrahydroisoquinolinyl radical, a phenazinyl radical, a carbazolyl radical, a 1,2,3,4-tetrahydrocarbazolyl radical or a 10,11-dihydro-dibenz[b,f]azepinyl radical;
or the two adjacent radicals R₁ and R₂ represent the grouping —V—(CH₂)r-W—, where V and W are selected independently of one another from the groupings —O—, —S—, —N(C₁-C₆)-alkyl-, —NC₆H₅—, —CH₂—, —C(CH₃)₂—, —C(C₂H₅)₂— or —C(C₆H₅)₂—; r represents an integer from 1 to 3; if this numerical value is 2 or 3, a benzene ring may also be fused to two adjacent CH₂ groups; V or W together with the corresponding adjacent CH₂ group can also represent a fused benzene ring;
and wherein the radicals R₄, R₅, R₆ each independently represent a substituent selected from hydrogen, a (C₁-C₆)-alkyl radical, a (C₃-C₇)-cycloalkyl radical, a phenyl radical, a benzyl radical, a biphenyl radical or a naphthyl radical; where m represents an integer from 1 to 3;
or two adjacent radicals R₄ form a fused benzene ring which can be unsubstituted, mono- or disubstituted, where the substituents can be selected from hydrogen, a (C₁-C₆)-alkyl radical, a (C₁-C₆)-alkoxy radical, a phenyl radical, a benzyl radical, a biphenyl radical or a naphthyl radical;
or the radicals R₅ and R₆, together with the carbon atom bonded to these radicals, form a three- to eight-membered carbo- or heteromonocyclic ring and to which one to two aromatic or heteroaromatic ring systems can be fused, the ring system(s) being independently selected from benzene, naphthalene, phenanthrene, pyridine, quinoline, furan, thiophene, pyrrole, benzofuran, benzothiophene, indole and carbazole.

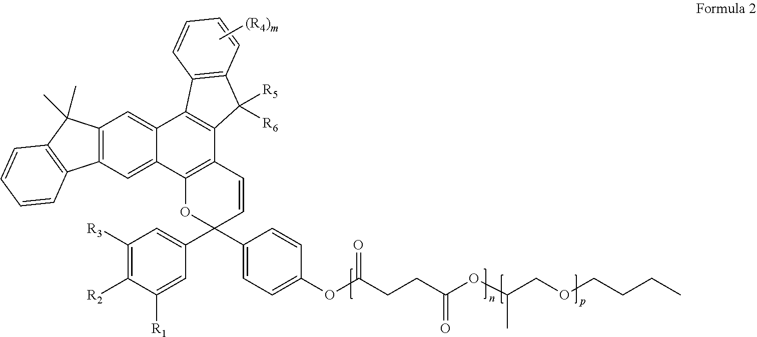

Example E1 are lenses made from sprues on plastic glass main bodies made of polythiourethane. These are prepared, preferably produced in advance, in a method step S100 and are made from a casting resin mixture with MR8 components (Mitsui Chemicals). These widely used mixtures result in optical plastics material with a refractive index n 1.6. To simplify index matching, the sprue is also based on MR8 poly(thio)urethane casting resin. The isocyanate component in accordance with Table 2 is introduced and a photochromic dye according to formula 1 with a linear polypropylenoxy substituent is applied. The other components are then added at room temperature while stirring to form the poly(thio)urethane and the catalyst dibutyltin dichloride. The clear solution is evacuated for 1 h (3×10⁻¹ mbar). After a standing time in accordance with Table 2, the casting resin thus obtained is filled into the casting package in method step S112. Curing occurs at a temperature range between room temperature and 125° C. Clear lenses with good photochromic properties are obtained.

In Diagram 2 (see FIG. 6; diagram 1 shows the viscosity curve of the casting resin mixture A by way of example), the transmission curve of a correspondingly produced sample body without optical effect is shown.

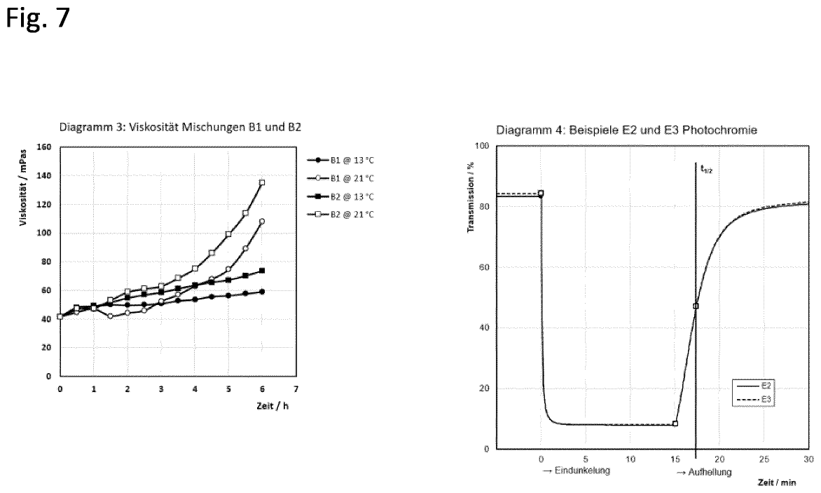

Examples E2 and E3 are prepared using the same method as Example E1. These examples were produced in larger quantities using a production facility (evacuable, temperature-controlled stirring tank for casting resin). Table 3 shows, using mixtures B1 and B2, how the above-mentioned parameters lead to an increase in the viscosity of the photochromic casting resin mixture: in this example, the service life of the casting resin after the mixing process, temperature, concentration of the catalyst dibutyltin dichloride. The mixture B2 used for examples E2 and E3 contains 500 ppm of catalyst, different polythiols, polyols and the dye mixture B consisting of dyes of formula 2 (see Table 2). Examples E2 and E3 show the production of samples with short and long service life in the circulated casting resin reservoir of an inventive (filling) device. While example E2 was easy to produce due to its low viscosity, the requirements for E3 are considerably higher after multiple hours of casting resin standing time (see Table 3, Diagram 3, FIG. 7).

TABLE 3
Time-dependent viscosity of poly(thio)urethane casting
resins with different catalyst concentrations
Casting resin mixtures see Table 2

| | | Mixture B1 | | Mixture B2 | |
|---|---|---|---|---|---|
| | | (250 ppm cat) | | (500 ppm cat) | |
| | | Viscosity [mPas] | | Viscosity [mPas] | |
| | Time | B1 @ | B1 @ | B2 @ | B2 @ |
| | t[h] | 13° C. | 21° C. | 13° C. | 21° C. |
| Mixture | 0.0 hours | 41.4 mPas | 41.4 mPas | 41.6 mPas | 41.6 mPas |
| Evacuation | 0.5 hours | 46.5 mPas | 44.6 mPas | 48.1 mPas | 47.2 mPas |
| | 1.0 hour | 48.6 mPas | 46.8 mPas | 49.0 mPas | 47.4 mPas |
| Stirring | 1.5 hours | 49.8 mPas | 42.0 mPas | 51.5 mPas | 53.0 mPas |
| under | 2.0 hours | 49.5 mPas | 44.0 mPas | 54.6 mPas | 58.7 mPas |
| Nitrogen | 2.5 hours | 49.8 mPas | 45.8 mPas | 56.7 mPas | 61.0 mPas |
| | 3.0 hours | 50.6 mPas | 52.2 mPas | 58.5 mPas | 62.8 mPas |
| | 3.5 hours | 52.5 mPas | 56.7 mPas | 61.0 mPas | 68.5 mPas |
| | 4.0 hours | 53.5 mPas | 62.8 mPas | 63.5 mPas | 75.1 mPas |
| | 4.5 hours | 55.5 mPas | 67.6 mPas | 65.5 mPas | 86.0 mPas |
| | 5.0 hours | 56.2 mPas | 74.5 mPas | 67.1 mPas | 99.0 mPas |
| | 5.5 hours | 57.5 mPas | 89.0 mPas | 70.0 mPas | 113.6 mPas |
| | 6.0 hours | 58.9 mPas | 108.0 mPas | 73.5 mPas | 135.2 mPas |

Diagram 3 (cf. FIG. 7) shows the viscosity curve of the casting resin mixtures B1 and B2 with different catalyst concentrations at two temperatures and illustrates the advantages of the inventive method for series production with longer service lives of the casting resin at high quantities and higher temperatures.

The casting resin for example E2 has a relatively low viscosity, while that for E3 has a long service life with a correspondingly higher viscosity. In both cases, clear, high-quality lenses with good photochromic properties are obtained. An advantage for series production is that the photochromic properties are independent of the service life of the casting resin (see Diagram 4 in FIG. 7, measurement as described for example E1). Neither the casting resin service life nor the temperature in the casting resin reservoir showed any significant influence on the photochromic properties, as can also be seen from Table 2 (cf. transmission in the darkened state Ts; half-life of the brightening; Diagram 4, FIG. 7). An inventive (sprue) method can advantageously ensure reproducible production and reliable pairability of the photochromic products.

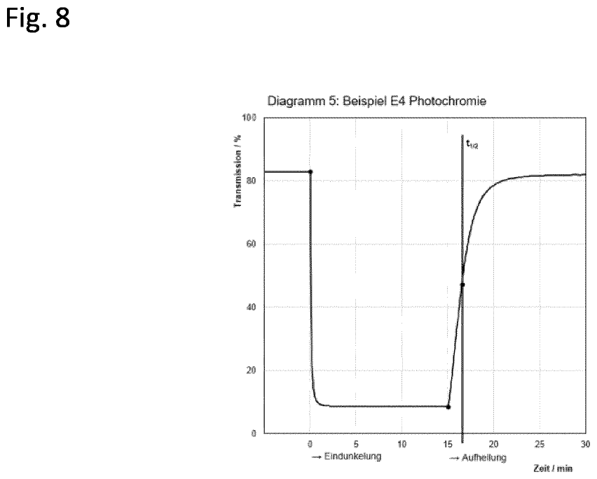

Example E4 is produced using the same method as Example E1. The casting resin contains 500 ppm catalyst, different polythiols, polyols, the single dye B in accordance with formula 2, and an epoxy as an adhesion-promoting additive (see Table 2). Clear lenses with photochromic properties are obtained. Diagram 5 (see FIG. 8) shows the transmission curve of a sample body produced by the sprue process without optical effect. Maximum darkening τᵥ₁ after 15 min excitation and half-life of the brightening of τᵥ₁ after τᵥ₀ (non-excited state) are listed in Table 2.

In the present disclosure, “comprises an X” generally does not imply a conclusive enumeration; rather, it is a short form of “comprises at least one X” and also comprises “comprises two or more Xs” and “also comprises Y in addition to X.” Although exemplary embodiments have been explained in the preceding description, it is pointed out that a large number of modifications is possible. It is also pointed out that the exemplary embodiments are merely examples that are not intended to restrict the scope of protection, the applications, and the structure in any way. Rather, the preceding description provides a person skilled in the art with guidelines for implementing at least one exemplary embodiment, with various changes, in particular with regard to the function and arrangement of the described components, being able to be made without departing from the scope of protection as it arises from the claims and from these equivalent combinations of features.

While the present invention has been illustrated by a description of various embodiments, and while these embodiments have been described in considerable detail, it is not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method, and illustrative example shown and described. Accordingly, departures may be made from such details without departing from the spirit and scope of the general inventive concept.

### LIST OF REFERENCE SIGNS

1 casting package
2 filling device
3 opening device
5 widening
5a widening in the mold shell
5b widening in the main body
5c widening in the mold shell and main body
10 main body
11 mold shell
12 cavity
13 sealing tape or tape
16 inlet opening
17 outlet opening
20 overlying molded part
21 casting resin supply line
22 pressure device
23 mechanical guide
24 casting resin reservoir
30 element for forming an opening
31 mechanical device

What is claimed is:

1-14. (canceled)

15. A method for producing a lens, in particular a spectacle lens, comprising:
obtaining a lens main body;
obtaining a mold shell;
arranging the main body and the mold shell in such a way that a cavity is formed between the main body and the mold shell;
applying a sealing tape to the main body and mold shell to thereby seal the cavity formed between the main body and the mold shell to obtain a casting package;
the casting package having at least one opening;
pressing a sealing part against the casting package at the at least one opening;
filling the cavity with a casting resin through the at least one opening;
removing the sealing tape; and
removing the mold shell to release the lens;
wherein filling the cavity comprises filling the cavity with the casting resin from a casting resin reservoir through a supply line coupled with the sealing part;
the sealing part comprising at least one elastic layer adapted for resting on the casting package at least during the filling; and
wherein a gap dimension of the cavity is smaller than one thousand micrometers.

16. The method of claim 15, wherein filling the cavity takes place at least one of:
under excess pressure; or
at least partially against the direction of gravity.

17. The method of claim 15, further comprising at least one of:
forming the at least one opening in the sealing tape;
arranging the casting package in a holding apparatus;
closing the at least one opening;
removing the casting package filled with a casting resin from the holding apparatus; or
curing the casting package.

18. The method of claim 15, wherein pressing the sealing part against the casting package comprises pressing the sealing part against the casting package with a pressing device.

19. The method of claim 15, further comprising at least one of:
forming the at least one opening in the sealing tape after applying the sealing tape; or
forming the at least one opening in the sealing tape using an opening device.

20. The method of claim 19, wherein the opening device operates at least one of mechanically, thermally, or using laser light.

21. The method of claim 15, further comprising:
adjusting at least one of the sealing part or an opening device relative to the casting package arranged in a holding apparatus using a mechanical guide;
the opening device configured for forming the at least one opening in the sealing tape.

22. The method of claim 15, wherein:
the at least one opening comprises at least two openings formed in the sealing tape;
filling the cavity with the casting resin comprises filling the cavity through a first of the at least two openings; and
at least one of:
the cavity is also filled with the casting resin through at least a second of the at least two openings, or
gas escapes from the cavity through the at least a second of the at least two openings during the filling.

23. The method of claim 15, wherein the casting resin forms a photochromic coating.

24. The method of claim 15, wherein the cavity formed between the main body and the mold shell comprises a gap widening in a region around the at least one opening.

25. The method of claim 24, wherein at least one of:
at least one of the mold shell or the main body comprises a continuous receding of the cavity-delimiting surface, at least in a portion of the gap widening;
the gap widening extends over an entire circumference of the cavity; or
the method further comprises removing at least one main body edge delimiting the gap widening from the resulting lens.

26. The method of claim 25, wherein the continuous receding of the cavity-delimiting surface is linear.

27. The method of claim 15, wherein the sealing tape comprises at least one of a carrier material or an adhesive.

28. The method of claim 15, wherein at least one of:
the curing of the casting package comprises at least one of a thermal or a photochemical curing of the casting package;
at least one method parameter is adjusted depending on a viscosity of the casting resin;
the casting resin comprises a viscosity of up to 800 mPas at least one of during the filling or in the uncured state; or
the casting resin comprises one or more, or a combination of two or more, of the following:
polyurethane and polythiourethane casting resins,
polyacrylate and polymethyl methacrylate casting resins,
polycarbonate and polydiethylene glycol bis(allyl carbonate) casting resins,
multifunctional isocyanates, isothiocyanates and/or episulfides,
multifunctional alcohols and/or thiols,
multi- and/or monofunctional acrylates and/or methyl methacrylates,
multi- and/or monofunctional allyl carbonates, or
multi- and/or monofunctional diethylene glycol bis(allyl carbonates).

29. The method of claim 28, wherein at least one of:
the polyurethane and polythiourethane casting resins are thermally curable polyurethane and polythiourethane casting resins;
the polyacrylate and polymethyl methacrylate casting resins are at least one of thermally curable or photochemically curable polyacrylate and polymethyl methacrylate casting resins; or
the polycarbonate and polydiethylene glycol bis(allyl carbonate) casting resins are thermally curable polycarbonate and polydiethylene glycol bis(allyl carbonate) casting resins.

30. A system for producing a lens, in particular a spectacle lens, the system comprising:
a mold shell;
a holding apparatus configured for receiving a casting package for filling, the casting package comprising a lens main body and the mold shell;
the mold shell configured to engage the main body and define a cavity therebetween, wherein the cavity has a gap dimension that is smaller than one thousand micrometers;
a casting resin reservoir, a supply line communicating with the reservoir, and a sealing part coupled with the supply line, the sealing part adapted for engaging and filling the cavity with casting resin from the reservoir through at least one opening in the casting package; and
a pressing device for pressing the sealing part and casting package against one another.

31. The system of claim 30, further comprising at least one of:
an opening device configured for forming the at least one opening in the sealing tape;
a device for closing the at least one opening; or
a curing device configured for curing the casting package.
